(19) United States
(12) Patent Application Publication
(10) Pub. No.: US 2016/0076813 A1
(43) Pub. Date: Mar. 17, 2016

(54) HEAT EXCHANGER FOR HEATING BULK SOLIDS

(71) Applicants: SOLEX THERMAL SCIENCE INC., Calgary (CA); NV DESMET BALLESTRA GROUP S.A., Zaventem (BE)

(72) Inventors: Farah Skold, Calgary (CA); Timothy Gerard Kemper, Marietta, GA (US); Marc Jules Adelin Ghislain Kellens, Muizen (BE); Etienne Le Clef, Wezembeek-Oppem (BE)

(21) Appl. No.: 14/851,806

(22) Filed: Sep. 11, 2015

Related U.S. Application Data
(60) Provisional application No. 62/049,933, filed on Sep. 12, 2014.

(51) Int. Cl. F26B 17/12; F26B 21/00; F26B 17/16

(52) U.S. Cl. CPC F26B 17/126; F26B 17/16; F26B 21/004

(57) ABSTRACT

A heat exchanger includes a housing including an inlet for receiving bulk solids, and an outlet for discharging the bulk solids, a plurality of spaced apart, substantially parallel heat transfer plate assemblies disposed within the housing, between the inlet and the outlet for heating the bulk solids that flow from the inlet, through spaces between the heat transfer plate assemblies, and at least two gas handling zones including a first gas handling zone and a second gas handling zone spaced from the first gas handling zone, the two gas handling zones disposed between the inlet and the outlet for entry of a pulsed flow of air into the housing and around the bulk solids and for exit of the pulsed flow of air from the housing.

### CROSS REFERENCE TO RELATED APPLICATION

The present application claims priority to U.S. Provisional Application No. 62/049,933, filed on Sep. 12, 2014, the entire specification of which is hereby incorporated by reference in its entirety.

### FIELD OF THE INVENTION

The present disclosure relates to heat exchangers for heating bulk solids, such as soy beans.

### BACKGROUND

Heat exchangers are used to heat bulk solids that flow, under the force of gravity, through the heat exchanger. Bulk solids such as soy beans are heated to reduce moisture content. In the example of soy beans, low drying temperatures are desirable to reduce moisture content without causing cracking of the soy beans. Typical systems are difficult to control and are inefficient for energy utilization. Efficiency of heating and control of drying temperatures and residence time in the heat exchanger are desirable.

Improvements to heat exchangers are desirable.

### SUMMARY

According to one aspect of an embodiment, a heat exchanger includes a housing including an inlet for receiving bulk solids, and an outlet for discharging the bulk solids, a plurality of spaced apart, substantially parallel heat transfer plate assemblies disposed within the housing, between the inlet and the outlet for heating the bulk solids that flow from the inlet, through spaces between the heat transfer plate assemblies, and at least two gas handling zones including a first gas handling zone and a second gas handling zone spaced from the first gas handling zone, the two gas handling zones disposed between the inlet and the outlet for entry of a pulsed flow of air into the housing and around the bulk solids and for exit of the pulsed flow of air from the housing.

According to another aspect of an embodiment, a method of heating bulk material includes introducing the bulk material into an inlet of a heat exchanger such that the bulk material passes between a plurality of spaced apart heat transfer plate assemblies to indirectly exchange heat with fluid flowing through the heat transfer plate assemblies, and, introducing pulsed gas into the heat exchanger such that the pulsed gas flows around the bulk solids.

### BRIEF DESCRIPTION OF THE DRAWINGS

Embodiments of the present invention will be described, by way of example, with reference to the drawings and to the following description, in which:

FIG. 1 is a perspective view of a heat exchanger for heating bulk solids, with a portion of a housing cut away, in accordance with an embodiment;

FIG. 2 is a side view of a heat transfer plate assembly of the heat exchanger of FIG. 1;

FIG. 3 is a cross-sectional view of a heat transfer tube of the heat exchanger of FIG. 1, drawn to a larger scale;

FIG. 4 is a top view of a first row of heat transfer tubes of the heat exchanger of FIG. 1;

FIG. 5 is a front view of rows of heat transfer tubes of the heat exchanger of FIG. 1;

FIG. 6 is a sectional side view of a portion of the heat exchanger of FIG. 1, including a portion of a heat transfer tube; and

FIG. 7 is an exploded perspective view of a portion of the heat exchanger of FIG. 1, including portions of heat transfer tubes.

### DETAILED DESCRIPTION OF THE PREFERRED EMBODIMENTS

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

The disclosure generally relates to heat exchangers for heating bulk solids. The heat exchanger includes a housing including an inlet for receiving bulk solids, and an outlet for discharging the bulk solids. A plurality of spaced apart, substantially parallel heat transfer plate assemblies are disposed within the housing, between the inlet and the outlet for heating the bulk solids that flow from the inlet, through spaces between the heat transfer plate assemblies. At least two gas handling zones including a first gas handling zone and a second gas handling zone spaced from the first gas handling zone, are disposed between the inlet and the outlet for entry of a pulsed flow of air into the housing and around the bulk solids and for exit of the pulsed flow of air from the housing.

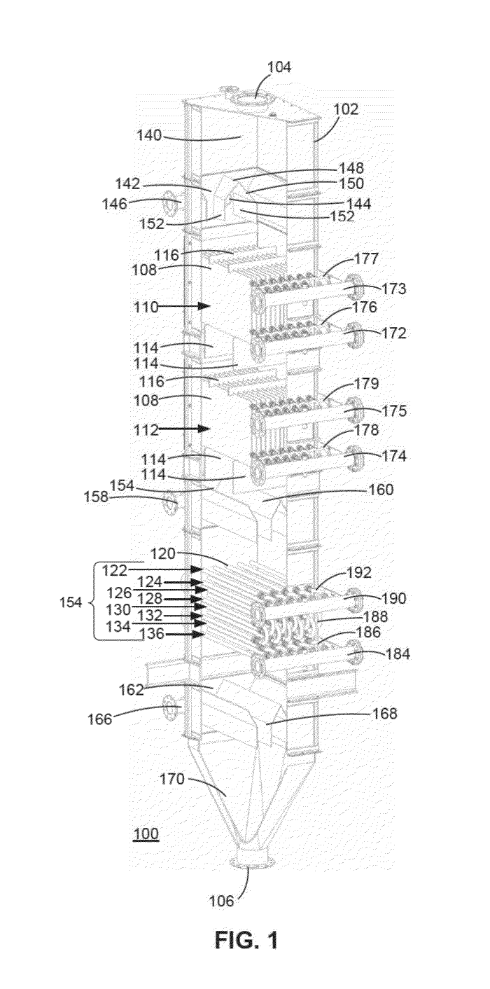

FIG. 1 shows a cutaway perspective view of an embodiment of a heat exchanger, with a portion of the housing cut away. The heat exchanger 100 includes the housing 102 that has a generally rectangular cross-section. The housing 102 includes an inlet 104 at a top thereof for introducing bulk solids into the heat exchanger 100. The bulk solids may be, for example, soy beans that have a temperature in the range of about 0° C. to about 20° C. The residence time of the bulk solids in the heat exchanger is about 25 minutes or greater. The bulk solids are heated to a temperature in the range of about 50° C. to about 70° C. The heat exchanger 100 is open to provide an outlet 106 for discharging heated bulk solids from the housing 102 of the heat exchanger 100.

A plurality of heat transfer plate assemblies 108 are disposed within the housing 102, between the inlet 104 and the outlet 106. The heat transfer plate assemblies 108 are arranged in rows. In the present example, the heat transfer plate assemblies 108 are arranged in two rows, referred to as banks 110, 112 of 12 plates in each bank 110, 112. The plurality of heat transfer plate assemblies 108 in each bank 110, 112 are spaced apart to leave spaces between adjacent heat transfer plate assemblies 108. The heat transfer plate assemblies 108 in the first bank 110 are generally parallel to each other. Similarly, the heat transfer plate assemblies 108 in the second bank 112 are generally parallel to each other. The first bank 110 is spaced vertically from the second bank 112. Each bank may be supported on support rails 114 that extend across the housing 102. The spacing between the heat transfer plate assemblies 108 is maintained by the support rails 114 and by top spacers 116 that extend across the housing. Although the heat exchanger 100 of FIG. 1 includes two banks 110, 112 of heat transfer plate assemblies 108, any other suitable number of banks of heat transfer plate assemblies 108 may be utilized and any other suitable number of heat transfer plate assemblies 108 may be utilized in each bank.

The heat transfer plate assemblies 108 may be generally vertically aligned such that the heat transfer plate assemblies 108 of the first bank 110 are generally vertically aligned with respective heat transfer plate assemblies 108 of the second bank 112.

A plurality of heat transfer tubes 120 are disposed within the housing 102, between the heat transfer plate assemblies 108 and the outlet 106. The heat transfer tubes 120 are arranged in rows. In the present example, the heat transfer tubes 120 are arranged in a single group. The group 154 includes 8 rows 122, 124, 126, 128, 130, 132, 134, 136. In each of the rows 122, 124, 126, 128, 130, 132, 134, 136, the heat transfer tubes 120 are spaced apart and are arranged generally parallel to each other. The rows 122, 124, 126, 128, 130, 132, 134, 136 of heat transfer tubes 120 are also spaced apart such that the first row 122 is vertically spaced from the second row 124, the second row 124 is vertically spaced from the third row 126, the third row 126 is vertically spaced from the fourth row 128, the fourth row 128 is vertically spaced from the fifth row 130, the fifth row 130 is vertically spaced from the sixth row 132, the sixth row 132 is vertically spaced from the seventh row 134, and the seventh row 134 is vertically spaced from the eighth row 136. For the purpose of the present example, each row 122, 124, 126, 128, 130, 132, 134, 136 of heat transfer tubes 120 includes 5 heat transfer tubes 120. Although 8 rows of heat transfer tubes 120 are shown, other suitable numbers of rows may be utilized and each row may include any other suitable number of heat transfer tubes 120.

The bank 110 of heat transfer plate assemblies 108 that is located closest to the inlet 104 is sufficiently spaced from the inlet 104 to provide a hopper 140 and a first gas handling zone 142 between the hopper 140 and the bank 110 of heat transfer plate assemblies 108.

The first gas handling zone 142 includes a plurality of apertures 144 in the housing 102 that are in fluid communication with connecting pipes that are coupled to a first gas manifold 146 for the passage of gas, such as air or other gas, from the interior of the housing 102 into the first gas manifold 146 or from the first gas manifold 146 into the housing. The gas handling zone 142 also includes a first set of flow-directing covers 148, with each flow-directing cover 148 extending from one sidewall of the housing 102, above a respective one of the apertures 144, to an opposing sidewall of the housing. The flow-directing covers 148 direct the flow of bulk solids that flow, as a result of gravity, from the inlet 104, around the apertures 144. Thus, each aperture is associated with a flow directing cover 148. In the present example, the flow-directing covers 148 have a cross-section that including a chevron-shaped portion 150, with sidewalls 152 extending downwardly from the ends of the chevron-shaped portion 150. Bulk solids that flow near the top of the flow-directing covers 148 are directed to the spaces between the sidewalls 152 of adjacent flow-directing covers 148 or between a sidewall 152 of the flow-directing cover 148 and a sidewall of the housing 102. The bulk solids then distribute over substantially the whole cross-section of the heat exchanger 100 as the bulk solids enter the spaces between the heat transfer plate assemblies 108 in the first bank 110. For the purpose of this example, the first gas handling zone 142 includes 3 apertures 144 and 3 flow-directing covers 148.

A second gas handling zone 154 is disposed between the second bank 112 of heat transfer plate assemblies 108 and the plurality of heat transfer tubes 120. The second gas handling zone 154 includes a plurality of apertures that are in fluid communication with connecting pipes that are coupled to a second gas manifold 158 for the passage of gas, such as air or other gas, from the interior of the housing 102 into the second gas manifold 158 or from the second gas manifold 158 into the housing 102. The second gas handling zone 154 also includes a second set of flow-directing covers 160, with each flow-directing cover 160 extending from one sidewall of the housing 102, above a respective one of the apertures, to an opposing sidewall of the housing 102. The flow-directing covers 160 may be a similar shape as the flow-directing covers 148 and are therefore not further described herein. The second gas handling zone 154 may include apertures of a different size and may include a different number of apertures than the apertures 144 of the first gas handling zone 142. The second gas handling zone 154 may also include flow-directing covers 160 of a different size may include a different number of flow-directing covers 160 than the flow-directing covers 148 of the first gas handling zone 142.

The bottom row 136 of heat transfer tubes is sufficiently spaced from the outlet to provide a third gas handling zone 162. The third gas handling zone 162 includes a plurality of apertures that are in fluid communication with connecting pipes that are coupled to a third gas manifold 166 for the passage of gas, such as air or other gas, from the interior of the housing 102 into the third gas manifold 166 or from the third gas manifold 166 into the housing 102. The third gas handling zone 162 also includes a third set of flow-directing covers 168, with each flow-directing cover 168 extending from one sidewall of the housing 102, above a respective one of the apertures, to an opposing sidewall of the housing 102. The flow-directing covers 168 may be similar to the flow-directing covers 148 and are therefore not further described herein. The third gas handling zone 162 may include apertures of a different size may include a different number of apertures than the apertures 144 of the first gas handling zone 142 or the apertures of the second gas handling zone 154. The third gas handling zone 162 may also include flow-directing covers 168 of a different size and may include a different number of flow-directing covers 168 than the flow-directing covers 148 of the first gas handling zone 142 or the flow-directing covers 160 of the second gas handling zone 154.

For the purpose of the present example, the second gas handling zone 154 is utilized for the entry of gas into the housing 102 of the heat exchanger 100. The apertures of the second gas handling zone 154 are therefore inlets through which gas from the second gas manifold 158 enters the housing 102. The first gas handling zone 142 and the third gas handling zone 162 are utilized for the exit of gas from the housing of the heat exchanger 100. The apertures 144 of the first gas handling zone 142 and the apertures of the third gas handling zone 162 are therefore outlets through which gas exits the housing 102 and travels into the first gas manifold 146 and the third gas manifold 166. In this example, some of the gas that enters the housing 102 through the second gas handling zone 154 travels counter-current to the direction of travel of the bulk solids and out through the first gas handling zone 142. Other gas that enters the housing 102 through the second gas handling zone 154 travels co-current, with the direction of travel of the bulk solids, and out through the third gas handling zone 162.

Alternatively, the second gas handling zone 154 may be utilized for the gas to exit the housing 102 of the heat exchanger 100 and the first gas handling zone 142 and the third gas handling zone 162 may be utilized for entry of gas into the housing of the heat exchanger 100. Each of the gas handling zones may be utilized for entry or for exit of gas and the heat exchanger 100 may include any other suitable number of gas handling zones.

As indicated above, the gas may be air. The gas is introduced into the heat exchanger 100 in pulses by pumping pulses of gas into the second gas manifold 158. The gas may be introduced, for example, at a velocity of from about 0.1 m/s to above 1 m/s. A gas velocity of the pulses may be about 0.8 m/s. The gas is introduced in pulses, i.e., turned off and on, at a frequency of, for example, less than 100 Hz. The gas may be introduced at a frequency of less than 10 Hz. For example, the gas may be introduced at a frequency of from about 1 Hz to about 5 Hz. The gas may be introduced utilizing a bellow, butterfly valve, piston, rotary valve or any other suitable device.

According to an alternative embodiment, the first gas handling zone 142 may include tubes in fluid communication with the first gas manifold, rather than the apertures 144 and flow-directing covers 148. The tubes have openings and extend from the sidewall of the housing 102. Similarly, the second gas handling zone 154 and the third gas handling zone 162 may also include tubes with openings. According to this alternative, the tubes are coupled to the respective gas manifold for the passage of pulsed gas, through the tubes and out the openings, thereby introducing pulsed gas into the housing 102 or for the passage of pulsed gas through the openings and into the tubes, thereby providing an exit for the gas from the housing 102.

A discharge hopper 170 may be disposed at the outlet 106. The discharge hopper 170 is utilized to create a mass flow or “choked flow” of bulk solids and to regulate the flow rate of the bulk solids out of the heat exchanger 100. An example of a discharge hopper 170 is described in U.S. Pat. No. 5,167,274, which is hereby incorporated herein by reference. The term “choked flow” is utilized herein to refer to a flow other than a free fall of the bulk solids as a result of the force of gravity.

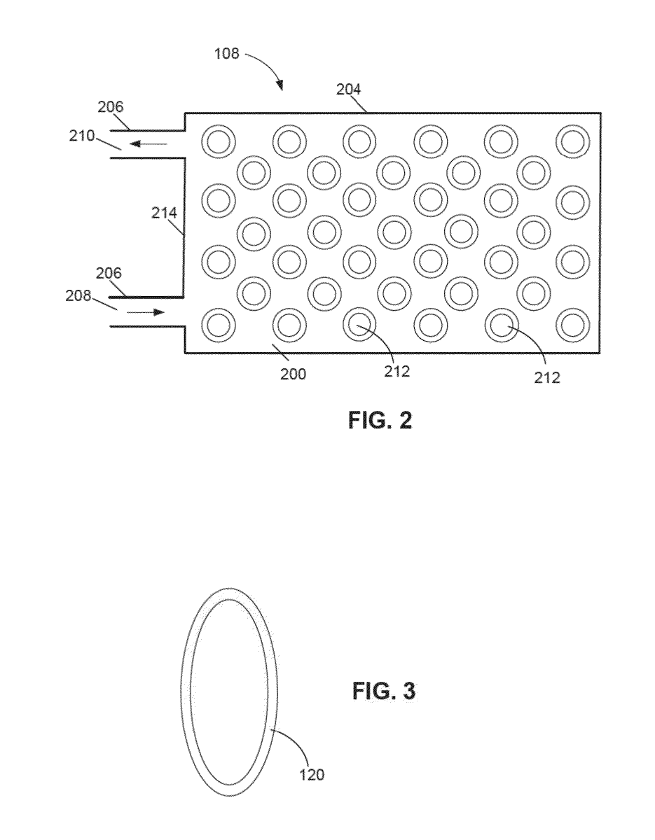

A side view of an example of a heat transfer plate assembly 108 of the heat exchanger 100 is shown in FIG. 2. The heat transfer plate assembly 108 includes a pair of metal sheets 200 that are welded together at locations distributed over the sheets to form dimples. The sheets are also seam welded along the edges 204 to join the edges together. After the two metal sheets 200 are welded together, slots are cut and nozzles 206 are inserted into the slots and welded to the sheets 200 to provide a fluid inlet 208 and a fluid outlet 210. The sheets 200 are inflated, utilizing the nozzles, to form passages through areas where the sheets 200 are not welded together, for the flow of fluid between the sheets 200. The locations at which the sheets are welded together form dimples or generally circular depressions 212 that are distributed across each sheet. The generally circular depressions 212 are distributed over each sheet 200 and are located at complementary locations on each sheet 200 such that the depressions 212 on one of the sheets are aligned with the depressions 212 on the other of the sheets 200.

The fluid inlet 208 extends from a front edge 214 of the sheets 200 at a location near the bottom of the sheets 200. The fluid outlet 210 extends from the front edge 214, at a location near the top of the sheets 200.

Referring again to FIG. 1, an inlet manifold 172 is utilized to provide heating fluid into the heat transfer plate assemblies 108 of the first bank 110 and a discharge manifold 173 is utilized to receive heating fluid discharged from the heat transfer plate assemblies 108 of the first bank 110. The inlet manifold 172 is coupled to the housing 102 and is in fluid communication with each fluid inlet 208 of the heat transfer plate assemblies 108 of the first bank 110 via respective inlet fluid lines 176. The discharge manifold 173 is coupled to the housing 102 and is in fluid communication with each fluid outlet 210 of the heat transfer plate assemblies 108 of the first bank 110 via respective outlet fluid lines 177.

Similarly, an inlet manifold 174 is utilized to provide heating fluid into the heat transfer plate assemblies 108 of the second bank 112 and a discharge manifold 175 is utilized to receive heating fluid discharged from the heat transfer plate assemblies 108 of the second bank 112. The inlet manifold 174 is coupled to the housing 102 and is in fluid communication with each fluid inlet 208 of the heat transfer plate assemblies 108 of the second bank 112 via respective inlet fluid lines 178. The discharge manifold 175 is coupled to the housing 102 and is in fluid communication with each fluid outlet 210 of the heat transfer plate assemblies 108 of the second bank 112 via respective outlet fluid lines 179.

Alternatively, a single inlet manifold may be coupled to the heat transfer plate assemblies 108 of the second bank 112 and a single outlet manifold may be coupled to the heat transfer plate assemblies 108 of the first bank 110. Each fluid outlet 210 of the heat transfer plate assemblies 108 of the second bank 112 may be in fluid communication with a respective fluid inlet 208 of the heat transfer plate assemblies 108 of the first bank 110 via respective coupling fluid lines.

FIG. 3 is a sectional view through the center of a heat transfer tube 120 of the heat exchanger 100. As illustrated, the center portion of the heat transfer tubes 120 have an oval shaped cross-section with a major axis of the heat transfer tubes 120 generally oriented in the vertical direction in the heat exchanger 100. The ends of the heat transfer tubes 120 may have a circular cross-section. Alternatively, the heat transfer tubes 120 may have any other suitable shape.

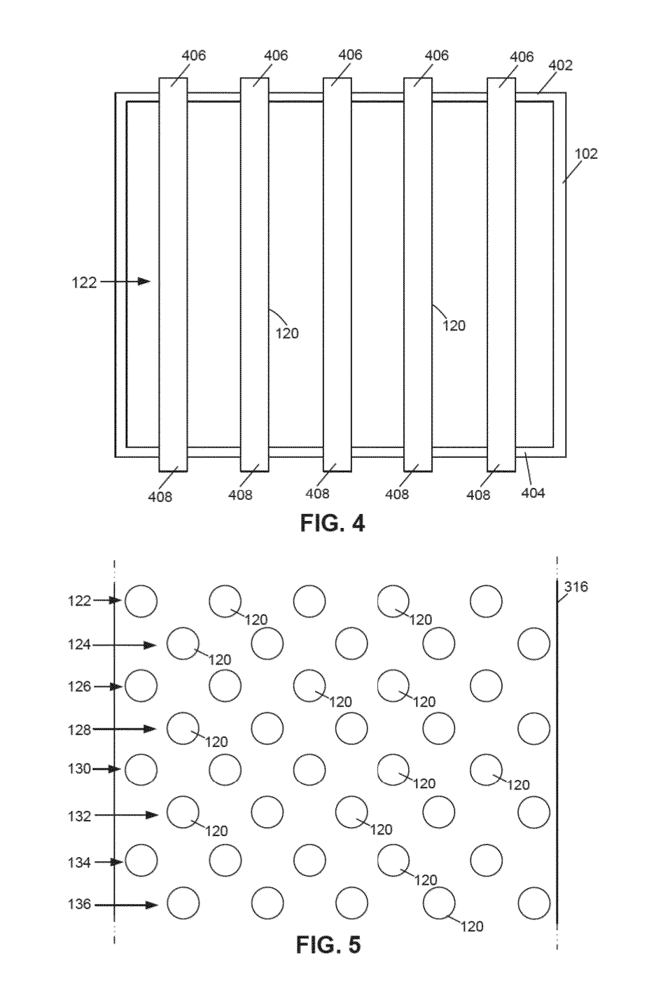

Referring now to FIG. 4 a top view of the first row 122 of the heat transfer tubes 120 is shown. Each heat transfer tube 120 extends a width of the housing 102, between a first side wall 402 and an opposing second side wall 404 of the housing 102. A first end 406 of each heat transfer tube 120 passes through an opening in the first side wall 402 of the housing 102 such that the first end 406 extends out of the housing 102. A second end 408 of each heat transfer tube 120 passes through an opening in the second side wall 404 of the housing 102 such that the second end 408 extends out of the housing 102. The heat transfer tubes 120 are arranged generally parallel to each other with spaces between adjacent heat transfer tubes 120. Each space between adjacent heat transfer tubes 120 provides a passageway for the flow of bulk solids therethrough. The second, third, fourth, fifth, sixth, seventh, and eighth rows 124, 126, 128, 130, 132, 134, 136 of the group 154 of heat transfer tubes 120 are similarly arranged.

Referring to FIG. 5, a front view of the rows 122, 124, 126, 128, 130, 132, 134, 136 of heat transfer tubes 120 is shown. The ends of the heat transfer tubes 120 have a generally circular cross-section. The heat transfer tubes 120 of the first row 122, which is closest to the heat transfer plate assemblies 108, and the heat transfer tubes 112 of the second row 124 are horizontally offset such that the heat transfer tubes 120 of the first row 122 are not vertically aligned with the heat transfer tubes 120 of the second row 124. The heat transfer tubes 120 of the second row 124 may be horizontally spaced from the heat transfer tubes 120 of the first row 122 by a distance that is equal to about one half of the spacing between adjacent heat transfer tubes 120 of the first row 122 and are vertically spaced by a suitable distance to facilitate flow and heating of the bulk solids.

The heat transfer tubes of the first row 122, the third row 126, the fifth row 130, and the seventh row 134 are vertically aligned. The heat transfer tubes 122 of the second row 124, the fourth row 128, the sixth row 132, and the eighth row 134 are also vertically aligned. The spaces between adjacent heat transfer tubes 120 in a single one of the rows 122, 124, 126, 128, 130, 132, 134, 136 provide passageways for the flow of bulk solids.

The terms top, bottom, horizontal, and vertical are utilized herein to provide reference to the orientation of the heat exchanger 100 when assembled for use, as shown in FIG. 1. The term heat transfer tube is utilized herein to refer to a conduit through which fluid may flow. As indicated with reference to FIG. 4, the heat transfer tube 120 is not limited to a cylindrical tube that has a circular cross-section. Any other suitable shape to facilitate fluid flow therethrough may be utilized.

Referring again to FIG. 1, the heat exchanger 100 also includes a tube inlet manifold 184 for providing heating fluid into each heat transfer tube 120 of the seventh row 134 and into each heat transfer tube 120 of the eighth row 136 of the first group 154 of heat transfer tubes 120. The tube inlet manifold 184 is coupled to the housing 102 and is in fluid communication with the first end 406 of each heat transfer tube 120 of the seventh row 134 and the first end of each heat transfer tube 120 of the eighth row 136 via respective inlet fluid lines 186.

The second end 408 of each of the heat transfer tubes 120 of the eighth row 136 is in fluid communication with the second end 408 of a respective one of the heat transfer tubes of the sixth row 132 via respective coupling fluid lines 188. The first end 406 of each heat transfer tube 120 of the sixth row is in fluid communication with the first end 406 of a respective one of the heat transfer tubes of the fourth row 128 via respective coupling fluid lines 188. The second end 408 of each of the heat transfer tubes 120 of the fourth row 128 is in fluid communication with the second end 408 of a respective one of the heat transfer tubes of the second row 124 via respective coupling fluid lines 188. The first end 406 of each heat transfer tube 120 of the second row 124 is in fluid communication with a tube discharge manifold 190 via respective discharge fluid lines 192.

The second end 408 of each of the heat transfer tubes 120 of the seventh row 134 is in fluid communication with the second end 408 of a respective one of the heat transfer tubes of the fifth row 130 via respective coupling fluid lines 188. The first end 406 of each heat transfer tube 120 of the fifth row 130 is in fluid communication with the first end 406 of a respective one of the heat transfer tubes of the third row 126 via respective coupling fluid lines 188. The second end 408 of each of the heat transfer tubes 120 of the third row 126 is in fluid communication with the second end 408 of a respective one of the heat transfer tubes of the first row 122 via respective coupling fluid lines 188. The first end 406 of each heat transfer tube 120 of the first row 122 is in fluid communication with the tube discharge manifold 190 via respective discharge fluid lines 192.

The heating fluid may be any suitable fluid that transfers heat from bulk solids. For example, the heating fluid may be steam to transfer heat via the heat transfer tubes 120.

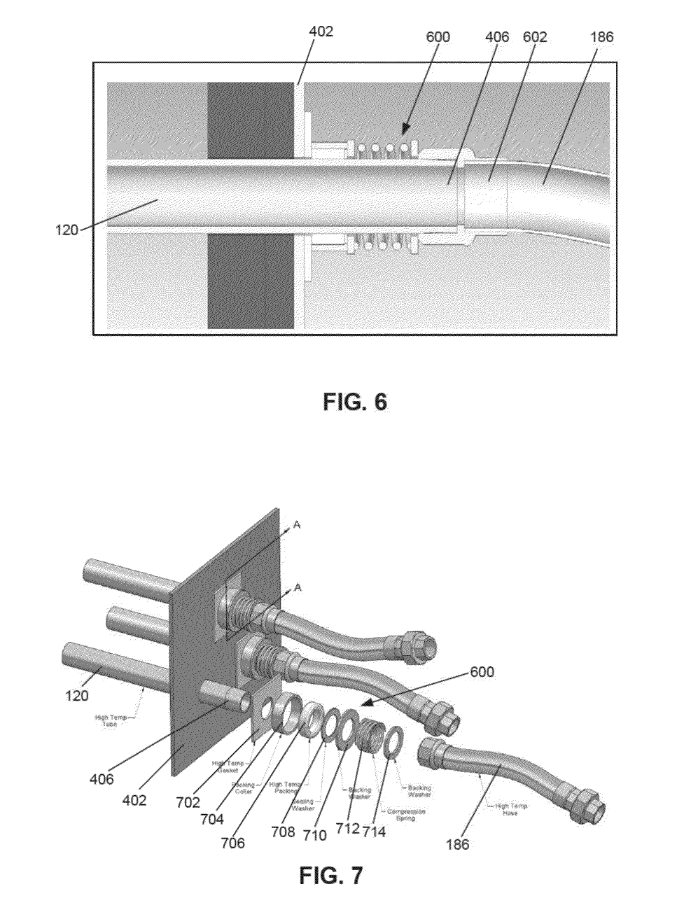

Referring to FIG. 6, a sectional side view of a portion of the heat exchanger 100 of FIG. 1 is shown, in which a first end 406 of a heat transfer tube 120 of the eighth row 136 is coupled to an end 602 of an inlet fluid line 186 utilizing a coupling 600. The first end 406 of the heat transfer tube 120 passes through an opening in the first side wall 402 of the housing 102 and extends therethrough. The coupling 600 facilitates slight movement of the heat transfer tube 120 within the housing 102 when heating fluid flows from the respective inlet fluid line 186 into the heat transfer tube 120.

Referring to FIG. 7, an exploded perspective view of an example of the coupling 600 is shown. The coupling 600 includes a high temperature gasket 702, a packing collar 704, a high temperature packing 706, a sealing washer 708, a first backing washer 710, a compression spring 712, and a second backing washer 714. The high temperature gasket 702 provides a seal against the first sidewall 402 of the housing 102 of the heat exchanger 100 to inhibit bulk solids from being discharged from the housing 102 through a gap (not shown) between the heat transfer tube 120 and the opening in the first sidewall 402 through which the first end 406 passes. The high temperature packing 706 seals against an outer surface of the heat transfer tube 120 to also inhibit bulk solids from discharging from the housing 102. The sealing washer 708 holds the high temperature packing 706 in place and centers the heat transfer tube 120 in the packing collar 704. The first backing washer 710 transfers pressure from the compression spring 712 to the packing collar 704, and in turn to the high temperature gasket 702 and the first sidewall 402 as heating fluid flows through the heat transfer tube 120. The second backing washer 714 acts as a backing for the compression spring 712, against the respective inlet fluid line 186.

The coupling 600 inhibits leakage when a heating fluid flows into a first end 406 of the heat transfer tube 120. Similar couplings 600 are utilized at the first and second ends of each of the heat transfer tubes 120 of the group 154, where the heat transfer tubes 120 are coupled to inlet fluid lines 186, coupling fluid lines 188, and discharge fluid lines 192.

In operation, heating fluid, which in this example is steam, flows from the tube inlet manifold 184, into the heat transfer tubes 120 of the eighth row 136 and the seventh row 134. The heating fluid flows in a serpentine manner through each of the heat transfer tubes 120 in each of the rows and out into the tube discharge manifold 190. As the steam flows through the heat transfer tubes 120, the steam is cooled and condenses into water. The water from the tube discharge manifold 190 is fed to the inlet manifold 174 and into the fluid inlets of the each heat transfer plate assemblies 108 of the second bank 112. The fluid flows substantially throughout each heat transfer plate assembly 108 of the second bank 112 and out through the fluid outlets of the heat transfer plate assemblies 108 and into the discharge manifold 175. The fluid may then be fed from the discharge manifold 175 to the inlet manifold 172 and into the fluid inlets of each of the heat transfer plate assemblies 108 of the first bank 110. The fluid flows substantially throughout each heat transfer plate assembly 108 of the first bank 110, out through the fluid outlets of the heat transfer plate assemblies 108, and into the discharge manifold 174.

Alternatively, the heating fluid that is fed to the fluid inlet manifold 174 and to the fluid inlet manifold 172 may be separate of the heating fluid from the tube discharge manifold 190 and other fluid such as a water may be utilized in the heat transfer plate assemblies 108. The heating fluid that is fed to the inlet manifold 174 may not come from or not directly from the tube discharge manifold 190. Although the flow of heating fluid has been described herein as flowing in a generally upward direction, the tube inlet manifold 184 and tube discharge manifold 190 may be exchanged such that the fluid flows from row to row, generally downwardly in the heat exchanger. Similarly, the inlet manifold 172 and the discharge manifold 173 may be exchanged and the inlet manifold 174 and discharge manifold 175 may be exchanged such that the fluid flows generally downwardly through the banks 110, 112.

The operation of the heat exchanger 100 will now be described with reference to FIG. 1. When bulk solids are fed into the housing 102, through the inlet 104, the bulk solids flow downwardly as a result of the force of gravity from the inlet 104 and into the hopper 118. The hopper 118 facilitates distribution of the bulk solids into the heat transfer plate assemblies 108. The bulk solids flow through spaces between the heat transfer plate assemblies 108, which spaces provide passageways through the banks 110, 112. The bulk solids that contact the heat transfer plate assemblies 108 are deflected into the passageways. As the bulk solids flow through the passageways, the bulk solids are heated.

After initial heating of the bulk solids, by the heat transfer plate assemblies 108, to an intermediate temperature, the bulk solids flow into the spaces between the heat transfer tubes 120, which provide passageways for the flow of bulk solids. Bulk solids that contact the heat transfer tubes 120 are deflected into the passageways. The heating fluid that flows through the heat transfer tubes 120 indirectly heats the bulk solids.

The bulk solids then flow from the passageways through the outlet 106, and into the discharge hopper 160, where the heated bulk solids are discharged under a “choked” flow.

The pulsed gas, which may be air, flows through the heat exchanger, around the bulk solids and disturbs or disrupts gas around particles of the bulk solids, facilitating heat exchange. Disturbing the gas around the particles of bulk solids improves heat exchange with the bulk solids as the bulk solids travel through the heat exchanger 100.

The heat transfer plate assemblies provide a large surface area over which heat transfer is effected and, as a result, water may be utilized as the heat exchange fluid, rather than steam. Thus, waste heat or water from the condensed steam from the heat transfer tubes may be fed to the heat transfer plate assemblies, improving efficiency of heating. With the use of the large heat transfer plate assembly areas and water, soy beans, for example, nearest the heat transfer plate assemblies during heating are heated gradually or at a slower pace compared to heating of soy beans solely utilizing steam as a heat exchange fluid. The slower pace of heating and increased residence time in the heat exchanger facilitates uniform heating to the core of the soy beans, for example, facilitating improved oil extraction with solvent after the soy beans are cracked and flaked (crushed). Slow heating also causes the hull to loosen from the bean and reduce the amount of hull, or seed coat, still adhering to the kernel after crushing. Cooking or cracking of the soy beans is also reduced.

The described embodiments are to be considered in all respects only as illustrative and not restrictive. The scope of the claims should not be limited by the preferred embodiments set forth in the examples, but should be given the broadest interpretation consistent with the description as a whole. All changes that come with meaning and range of equivalency of the claims are to be embraced within their scope.

1. A heat exchanger comprising:
a housing including an inlet for receiving bulk solids, and an outlet for discharging the bulk solids;
a plurality of spaced apart, substantially parallel heat transfer plate assemblies disposed within the housing, between the inlet and the outlet for heating the bulk solids that flow from the inlet, through spaces between the heat transfer plate assemblies;
at least two gas handling zones including a first gas handling zone and a second gas handling zone spaced from the first gas handling zone, the two gas handling zones disposed between the inlet and the outlet for entry of a pulsed flow of air into the housing and around the bulk solids and for exit of the pulsed flow of air from the housing.

2. The heat exchanger according to claim 1, comprising a plurality of spaced apart, substantially parallel heat transfer tubes disposed within the housing between the heat transfer plate assemblies and the outlet, for further heating the bulk solids that flow from the spaces between the heat transfer plate assemblies, through spaces between heat transfer tubes, to the outlet.

3. The heat exchanger according to claim 1, wherein each of the heat transfer plate assemblies includes an inlet and an outlet for the flow of a heating fluid through the heat transfer plate assemblies.

4. The heat exchanger according to claim 3, wherein each of the heat transfer plate assemblies comprises a pair of metal sheets that are coupled together and include at least one passage between the metal sheets for the flow of the heating fluid through the heat transfer plate assemblies.

5. The heat exchanger according to claim 4, wherein the pair of metal sheets are joined together at a plurality of spaced apart locations to facilitate flow of the heating fluid through the heat transfer plate assembly.

6. The heat exchanger according to claim 1, wherein the heating fluid that passes through the heat transfer plate assemblies comprises water.

7. The heat exchanger according to claim 1, wherein the heat transfer plate assemblies are arranged in at least two rows of spaced apart, substantially parallel heat transfer plate assemblies, including a first row and second row.

8. The heat exchanger according to claim 7, wherein the heat transfer plate assemblies of the first row are spaced from the heat transfer plate assemblies of the second row.

9. The heat exchanger according to claim 7, wherein the heat transfer plate assemblies of the first row are generally aligned with the heat transfer plate assemblies of the second row.

10. The heat exchanger according to claim 2, wherein the heat transfer tubes are arranged in a plurality of rows of heat transfer tubes.

11. The heat exchanger according to claim 10, wherein the heat transfer tubes of a first row of the plurality of rows are horizontally offset from the heat transfer tubes of a second row of the plurality of rows, such that the heat transfer tubes of the first row are not vertically aligned with the heat transfer tubes of the second row.

12. The heat exchanger according to claim 2, wherein the heat transfer tubes include a passage for the flow of a first heating fluid therethrough and the heat transfer plate assemblies include at least one passage for the flow of a second heating fluid therethrough.

13. The heat exchanger according to claim 12, wherein the first heating fluid comprises steam and the second heating fluid comprises water.

14. The heat exchanger according to claim 12, wherein the first heating fluid comprises steam and the second heating fluid comprises water from condensation of the steam.

15. The heat exchanger according to claim 1, comprising a discharge hopper at the outlet of the heat exchanger to provide choked flow of the bulk material.

16. A method of heating bulk material comprising:
introducing the material into an inlet of a heat exchanger such that the bulk material passes between a plurality of spaced apart heat transfer plate assemblies;
pumping fluid through the heat transfer plate assemblies to facilitate heating of the bulk material as the bulk material passes between the heat transfer plate assemblies;
introducing pulsed gas into the heat exchanger such that the pulsed gas flows around the bulk solids.

17. The method according to claim 16, wherein, after flow of the bulk material between the plurality of spaced apart heat transfer plate assemblies, the bulk material passes between heat transfer tubes.

18. The method according to claim 17, comprising pumping steam through the heat transfer tubes to facilitate heating of the bulk material as the bulk material passes between the heat transfer tubes.

19. The method according to claim 18, wherein the fluid that flows through the heat transfer plate assemblies comprises water received from condensation of the steam that flows through the heat transfer tubes.
